(19) United States
(12) Patent Application Publication
(10) Pub. No.: US 2008/0092695 A1
(43) Pub. Date: Apr. 24, 2008

(54) Bi-directional ratchet drive

(76) Inventor: Hector Ray Hernandez, Fullerton, CA (US)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 11/583,240

(22) Filed: Oct. 19, 2006

(51) Int. Cl. B25B 13/46

(52) U.S. Cl. 81/63.1; 81/62

(57) ABSTRACT

A ratchet drive mechanism is described providing novel and beneficial features to the user. In one aspect of the invention, a ratchet drive is provided possessing a full circumference free rotation feature. Specifically, when an outer cover of the mechanism is in a first position, the user may impact the exterior of the ratchet drive, and in fact may rotate an exterior cover, or outer switch, of the mechanism by a full circumference, without rotating the inner workings of the mechanism to change the drive direction of the ratchet.

### FIELD OF THE INVENTION

The present invention relates to reversible drivers, and relates more particularly to the ratchet transmission control mechanism of a driver.

### BACKGROUND OF THE INVENTION

Various reversible driver mechanisms are well known, and are popularly accepted. These reversible drivers commonly use a ratchet drive mechanism and a switch for controlling the transmission of driving power from the handle to the shaft. When the switch is shifted leftwards, a first pawl of the ratchet drive mechanism is forced into engagement with the ratchet on the shaft, and a second pawl is forced away from the ratchet. In this way, the shaft can be turned by the handle clockwise. When the switch is shifted rightwards, the second pawl of the ratchet drive mechanism is forced into engagement with the ratchet on the shaft, and the first pawl is forced away from the ratchet. In this way, the shaft can be turned by the handle counter-clockwise. In some embodiments, when the switch is shifted to a middle position, the first pawl and the second pawl are each forced into engagement with the ratchet. In this way, the shaft can be turned by the handle in both ways.

Shortcomings with such systems include the fact that the switching mechanism may inadvertently be bumped by the user from one position to another, causing the shaft to rotate in the wrong direction, or in both directions when only one direction is desired. This can be particularly undesirable when the user is in a confined space and unable to easily move his hands to reset the drive direction.

Thus, there exists a need for a ratchet drive mechanism that provides a degree of protection from this inadvertent result. The present invention is intended to be an improvement in connection with ratchet control mechanisms, for addressing these and other needs.

### SUMMARY OF THE INVENTION

According to a preferred embodiment of the invention, there is described an improved ratchet drive mechanism having features of the present invention. In one aspect of the invention, the ratchet drive includes an elongate drive shaft having an axis. A ratchet drum configured to receive the shaft through a bore in the ratchet drum is provided, and at least two pawls positioned within the ratchet drum, the pawls being configured to be moved to a first pawl position to lock the shaft rotationally immovable in relation to the ratchet drum in a clockwise driving direction while leaving the shaft free to rotate in an anticlockwise direction, and to be moved to a second pawl position to lock the shaft rotationally immovable in relation to the ratchet drum in a counterclockwise direction while leaving the shaft free to rotate in a clockwise direction. An inner switch is provided which is rotationally movable in relation to the ratchet drum for moving the pawls between the first pawl position and the second pawl position. An outer switch is provided to be rotationally movable in relation to the inner switch, the outer switch being movable along the shaft axis from a first outer switch position rotationally disengaged from the inner switch to a second outer switch position rotationally engaged with the inner switch. In an important aspect, when the outer switch is in the first outer switch position, it is configured to freely rotate without mechanical interruption. Thus, if the outer cover of the mechanism is inadvertently knocked or bumped, it will simply rotate freely without altering the drive direction of the drive mechanism.

In further aspects of the invention, the outer switch may be biased to the first outer switch position by a spring. The spring may be a helical spring surrounding the shaft, and it may be restrained against rearward movement along the shaft by the inner switch. Further, the inner switch may at least partially surrounds the ratchet drum, and the outer switch may at least partially surrounds the inner switch. Preferably, the inner switch is restrained against forward movement along the shaft by a first C-clip positioned in a first groove on the shaft, and the outer switch is restrained against forward movement along the shaft by a second C-clip positioned in a second groove on the shaft. Preferably, the inner switch has a plurality of diametrically extending teeth for engagement with mating teeth on the outer switch, and the inner switch has at least one post, extending parallel with the shaft axis, for engaging with and moving the pawls.

In a preferred method of selecting a drive direction in a ratchet drive mechanism, the invention includes providing a first member to rotate about an elongate drive shaft having an axis. The first member is configured to be capable of freely rotating about the drive shaft when the first member is in an original position along the shaft. The first member is axially retracted along the shaft from the original position, followed by engaging a second member with the first member, the second member being configured to rotate about the drive shaft. The first member is rotated, and the second member is rotated. Then, the drive direction of the drive mechanism is altered. Finally, the first member is returned to the original position.

In preferred aspects, retracting the first member includes retraction against a force exerted by a biasing member. Further, altering the drive direction of the drive mechanism may include rotating the second member by rotating the first member. Moreover, altering the drive direction may include altering the direction by rotating the second member. Finally, returning the first member to the original position may include releasing the first member after moving the pawls, and permitting a biasing member to return the first member to the original position. In this aspect, permitting a biasing member to return the first member includes providing no manual assistance in returning the first member to the original position.

Thus, in an important aspect of the invention, by configuring the first member to be capable of freely rotating about the drive shaft when the first member is in its original position, accidental knocks and bumps to the first member do not result in the drive direction of the mechanism being changed. Moreover, once the drive direction is changed, the user may merely release the first member, and it is biased to its original position without assistance from the user.

These and other advantages of the invention will become more apparent from the following detailed description thereof and the accompanying exemplary drawings.

### BRIEF DESCRIPTION OF THE DRAWINGS

FIG. 1 is a perspective view of a ratchet drive mechanism having features of the present invention.

FIG. 2 is a partially disassembled view of the mechanism of FIG. 1.

FIG. 3 is a further disassembled view of the mechanism of FIGS. 1-2.

FIG. 4 is a fully disassembled view of the mechanism of FIGS. 1-3.

FIGS. 5-7 are elevation, side, and top views respectively of the ratchet stop of the mechanism of FIGS. 1-4.

FIG. 8 is a sectional view taken substantially through the plane A-A shown in FIG. 1.

FIG. 9 is a perspective view from below of a first switch of the mechanism of FIG. 1.

FIG. 10 is a perspective view from below of a second switch of the mechanism of FIG. 1.

### DETAILED DESCRIPTION OF THE PREFERRED EMBODIMENTS

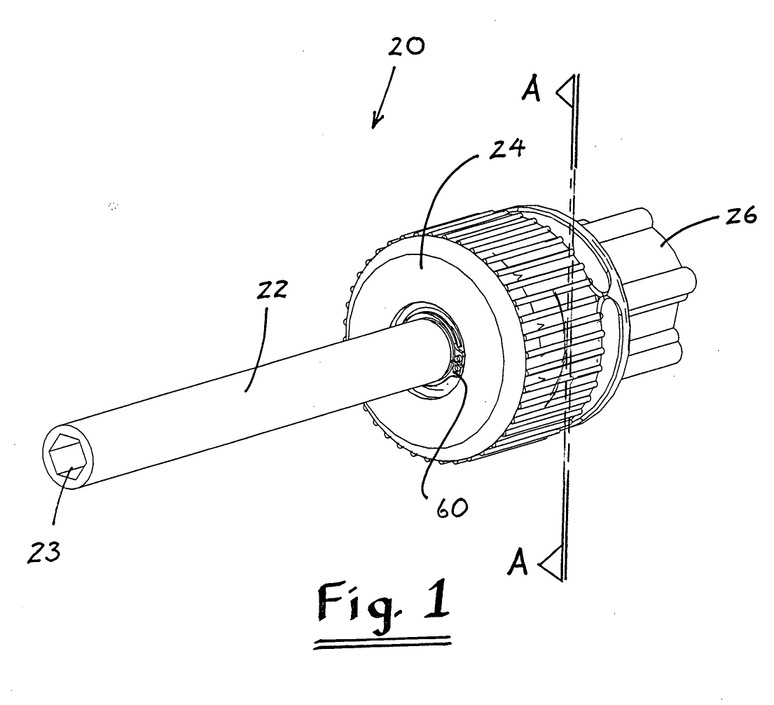

With reference to the drawings which are provided by way of example and not limitation, there is shown a ratchet drive mechanism incorporating features of the present invention. Referring to FIGS. 1-4, a ratchet drive mechanism 20 in accordance with the present invention is exemplified, generally comprising a shaft 22, an outer switch 24, an inner switch 28, and a ratchet drum 26. A handle (not shown) may be connected with the ratchet drum 26 for manipulating and rotating the drive mechanism 20.

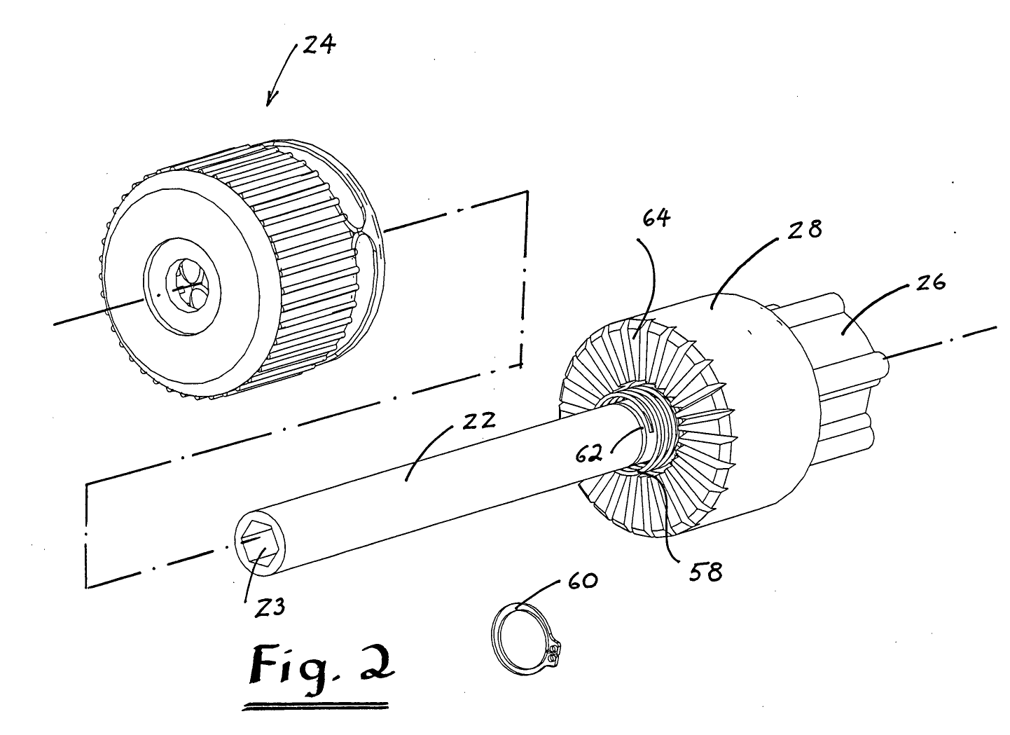

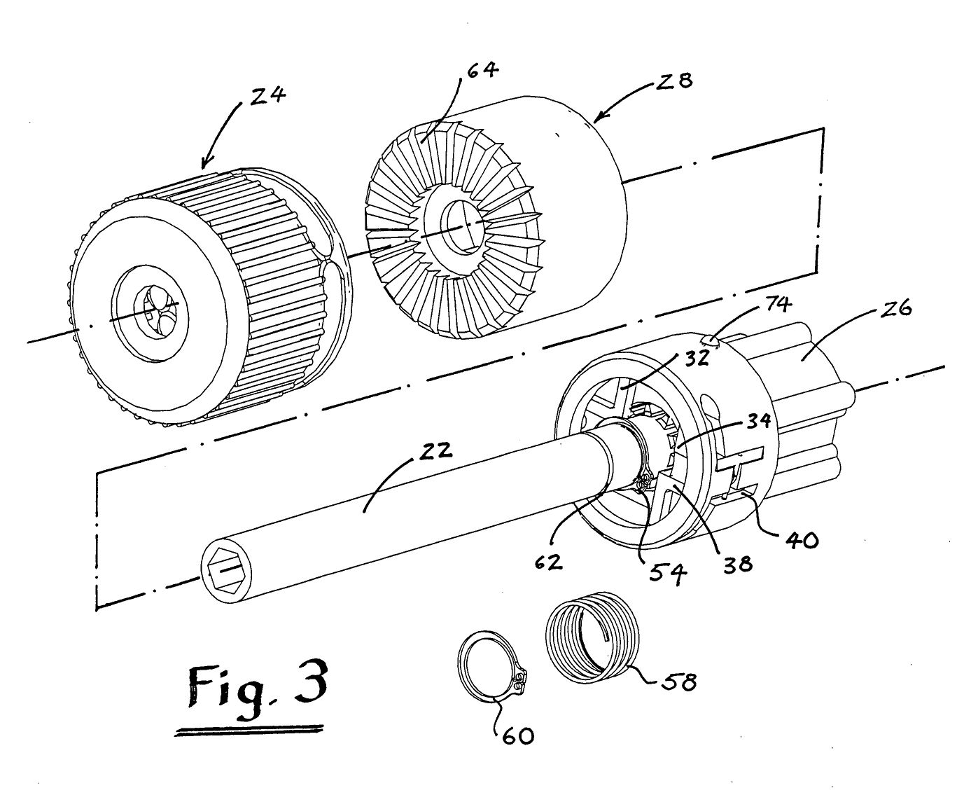

As exemplified in FIG. 1, the shaft 22 may include an opening 23 at the forward end, which preferably may be hexagonal in profile, and adapted to receive driver bits carrying tips of various sizes and shapes. Moving from FIG. 1 to FIG. 2, there is shown how the cylindrical outer switch 24 slides over the shaft 22, and fits rotatably over the cylindrical inner switch 28. A first C-clip 60, snapped into a groove 62 on the shaft, is configured to retain the outer switch 24 on the shaft 22. An axial spring 58 is positioned behind the outer switch to bias the outer switch forwardly. Moving from FIG. 2 to FIG. 3, there is shown how the cylindrical inner switch 28 slides over the shaft 22, and fits rotatably over the cylindrical ratchet drum 26. A second C-clip 54 snaps into a second groove 56 on the shaft to retain the inner switch on the shaft. (Accordingly, to install the inner switch 28 on the shaft, second C-clip 54 must be removed from second groove 56 as shown in FIG. 3, the inner switch must be installed, and the second C-clip snapped into second groove 56.)

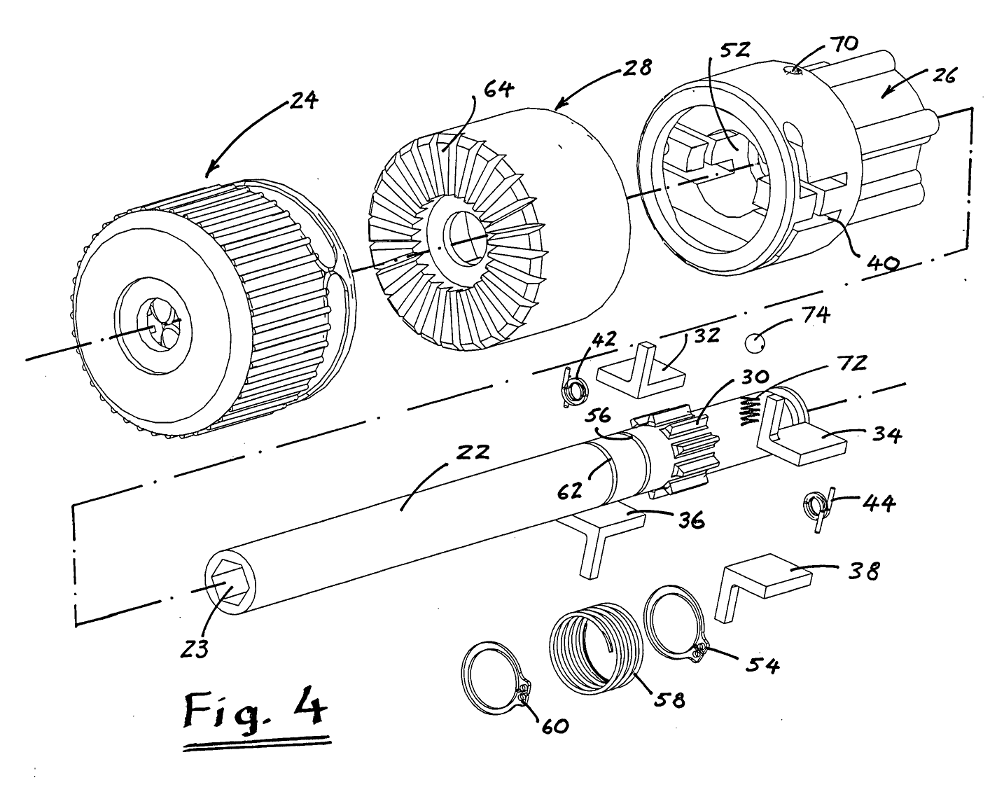

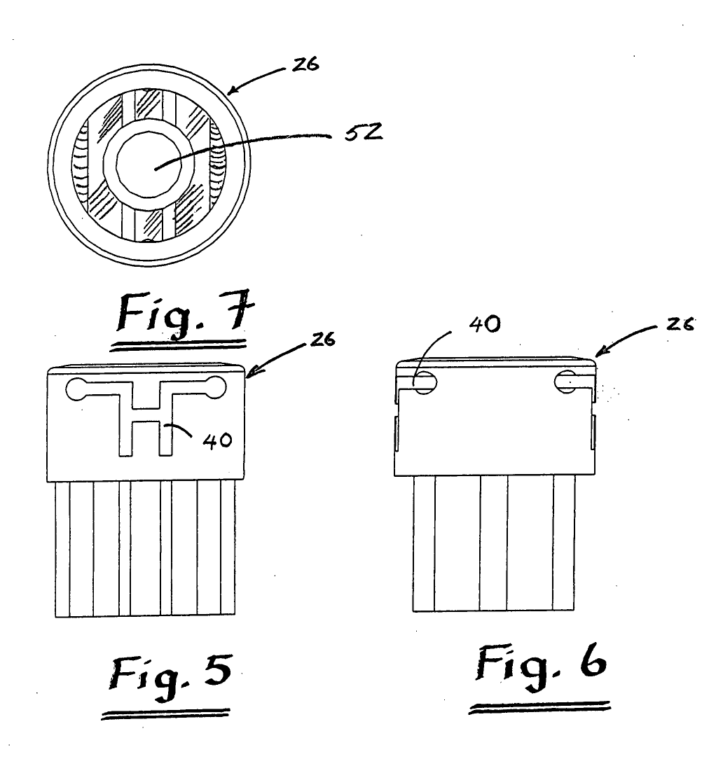

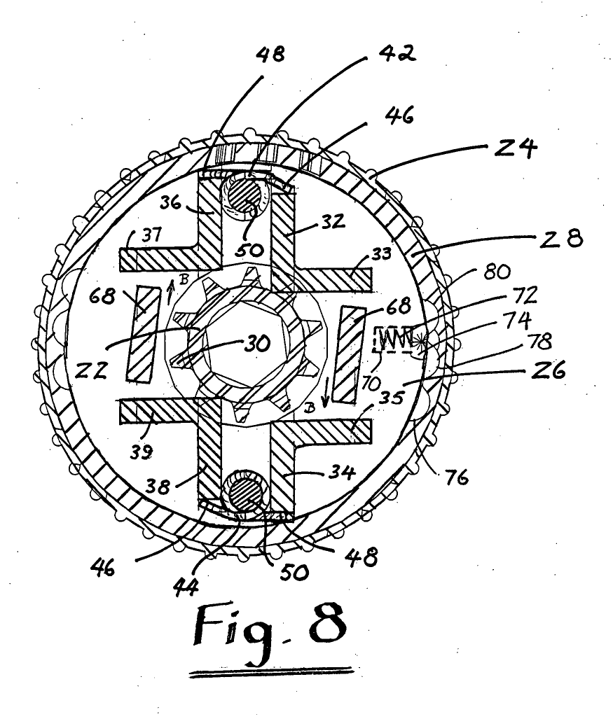

Referring now to FIG. 4, there is exemplified how the shaft 22 may include gear teeth 30 circumferentially surrounding the shaft 22 and extending radially. Two pairs of pawls 32, 34 and 36, 38 are provided and are configured to fit within a complex shaped slot 40 that is machined into the ratchet drum 26. Each pawl has a side arm, 33, 35, 37, 39 (FIG. 8), whose function is explained below. As best seen in FIG. 8, each pair of pawls is configured to allow inward bias by springs 42, 44. The springs 42, 44 are preferably looped from a single strand of wire, and arranged in relation to the ratchet drum to pivot about pins or screws 50 that may be inserted or screwed into the ratchet drum when the springs are correctly positioned after the pawls are inserted. The two springs 42, 44 each have two ends, 46, 48, each end configured to bias a pawl toward the gear teeth 30 on the shaft under the correct conditions as described below.

Under a preferred method of assembly, the pawls 32, 34, 36, 38 are first installed within the slot 40 in the ratchet drum 26. The shaft 22 is then inserted within a bore 52 (FIG. 3) in the ratchet drum, until the gear teeth 30 are positioned adjacent the pawls. Thereafter, the inner switch 26 is installed over the shaft, and over the ratchet drum, as exemplified in FIG. 2. At this stage, a first C-clip may 54 be snapped onto the shaft at a groove 56 to prevent both the inner switch 28 and the ratchet drum 26 from riding up the shaft. An axial spring 58 is slid over the shaft to abut the first C-clip, after which the outer switch 24 is slid over the shaft 22 and over the inner switch 28. A second C-clip 60 is snapped onto the shaft at a groove 62 to prevent the outer switch from riding up the shaft. In this configuration, the outer switch 24 may be manually depressed against the axial spring 58 towards contact with the inner switch 28, and upon release, the spring 58 will bias the outer switch out of contact with the inner switch.

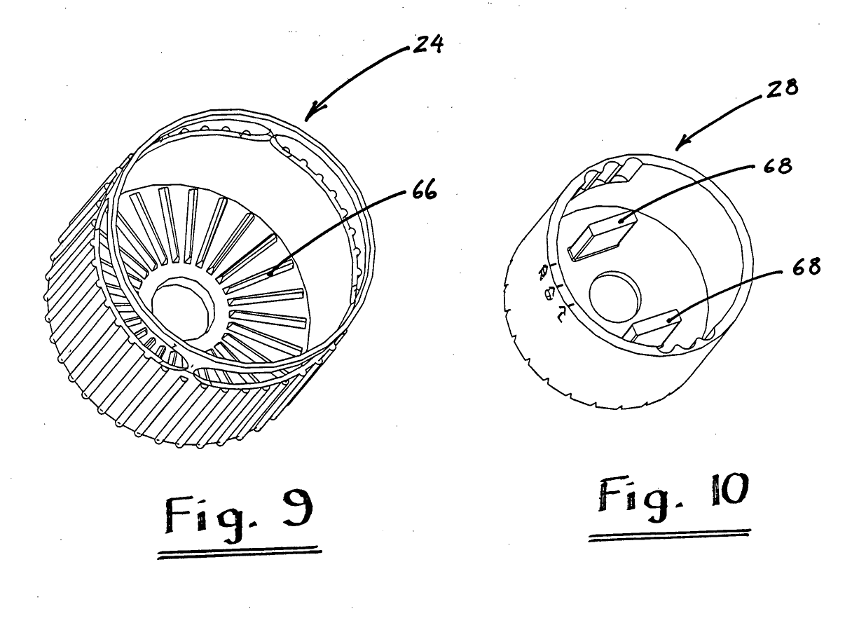

Further features of the inner switch 28 and outer switch include the following structure. On a surface of the inner switch 28 there are a plurality of preferably radial teeth 64 (FIGS. 2-4) which are configured to mate with teeth 66 (FIG. 9) on an opposing surface of the outer switch 24. When the outer switch 24 is manually depressed against the spring 58, the opposing teeth sets 64, 66 are configured to engage with each other, and to disengage when the depressing force is released. The inner switch 28 includes, affixed to a surface, posts 68 which preferably extend axially downwardly to be positioned adjacent the pawls 32, 34, 36, 38 when the mechanism is assembled (FIG. 8).

In order to stabilize the angular rotational position of the inner switch 28 in relation to the ratchet drum 26, a radial groove 70 is machined into the ratchet drum 26 for positioning a helical spring 72 within. A steel ball 74 is inserted in the groove at the end of the spring so that the spring biases the ball radially outwardly. The inner switch 28 is shaped to include three depressions, 76, 78, 80, each positioned at the level of the groove 70, and configured to receive a portion of the ball 72. When the inner switch is rotated, the outwardly biased ball may come to rest in one of the depressions, and, in combination with the spring 72, biases the inner switch 28 against further rotation in relation to the ratchet drum 26. This bias against rotation may be overcome by the user, to select stable positions for the inner switch 28 corresponding to the positions of the three depressions 76, 78, 80.

In use, and with reference to FIG. 8, the ratchet drive mechanism of the present invention may be operated as follows. The user, wishing to change the direction of the ratchet drive from clockwise to counterclockwise, manually depresses the outer switch 24, from a first forwardly position of equilibrium, against the bias of the spring 58 to a second rearwardly position where it engages the teeth 64, 66 interface on the inner switch 28 and outer switch 24. The outer switch is rotated to the right as indicated by the direction arrows B in FIG. 8, thereby rotating the inner switch by the same amount to the right. The posts 68 of the inner switch engage the side arms (in this case 39, 35) of two pawls (in this case 36, 34) in the pawl pairs, thus biasing those pawls away from engagement with the teeth 30 on the shaft 22. Each pawl that is biased away from the teeth biases the spring end (in this case 48) with which it is in contact, thereby biasing the opposite spring end 46 toward the teeth 30. The spring end 46 in turn biases the remaining pawl (32, 38) in each pawl pair toward the teeth. A corner of the latter pawls 32, 38 is thus inserted between the teeth to prevent the shaft from rotating in a counterclockwise direction in relation to the ratchet drum 26. At this point, the biased ball 74 is configured to snap into one of the depressions 76, 78, 80, to hold the ratchet drum 26, and hence the pawls, in a fixed and stable angular relationship with the shaft 22. This will allow any rotational force applied by the user to the ratchet drum via a handle (not shown) to be transmitted to the shaft for rotating a driver tip or the like. It also has the result that when the user rotates the mechanism in the direction opposite to the driving direction, the teeth, because of their shape, do not lock on the pawls 32, 38, but bias them out of the way against the bias of spring ends 46, causing the familiar clicking sound of a ratchet drive mechanism.

It will be further appreciated that, by depressing the outer switch 24 rearwardly into contact with the inner switch, and turning the outer switch leftwards will have the same result as above, only in a reverse direction, causing the alternate pawls 34, 36 to engage with the teeth 30 while pawls 32, 38 disengage (not shown), and providing a clockwise driving direction for the shaft. A final possibility is for the user to rotate the switches 24, 28 to set the pawls in an intermediate position (not shown) in which all the pawls engage the teeth to provide both a clockwise and anti-clockwise driving direction.

Once the pawls are moved to the desired position in the ratchet drum as above, the user releases hold of the outer switch 24. The axial spring 58 urges the outer switch 24 axially forwardly along the shaft, thereby disengaging the sets of teeth 64, 66 between the two switches 28, 24 respectively from each other.

It will now be appreciated that, when the outer switch 24 is its forwardly position as set by the axial spring, any unintentional impact to the outer switch 24 will cause the outer switch to rotate freely about the inner switch, without resetting the position of the pawls to reverse the drive direction of the ratchet drive mechanism, or engage the mechanism to drive in both directions. This feature provides the advantage that the user will not frequently find the drive direction being accidentally switched by inadvertent bumps or knocks to the switching mechanism, a characteristic common in prior art devices and highly annoying when the user is working in an awkward or confined space that prevents him from easily resetting the switch.

The present invention may, of course, be carried out in other specific ways than those herein set forth without departing from the essential characteristics of the invention. The present embodiments are, therefore, to be considered in all respects as illustrative and not restrictive, and all changes coming within the meaning and equivalency range of the appended claims are intended to be embraced therein.

We claim:

1. A ratchet drive mechanism comprising:
a drive shaft having an elongate axis;
a ratchet drum configured to receive the shaft through a bore in the ratchet drum;
at least two pawls positioned within the ratchet drum, the pawls being configured to be moved to a first pawl position to lock the shaft rotationally immovable in relation to the ratchet drum in a clockwise driving direction while leaving the shaft free to rotate in an anticlockwise direction, and to be moved to a second pawl position to lock the shaft rotationally immovable in relation to the ratchet drum in a counterclockwise direction while leaving the shaft free to rotate in a clockwise direction;
an inner switch rotationally movable in relation to the ratchet drum for moving the pawls between the first pawl position and the second pawl position; and
an outer switch rotationally movable in relation to the inner switch, the outer switch being movable along the shaft axis from a first outer switch position rotationally disengaged from the inner switch to a second outer switch position rotationally engaged with the inner switch;
wherein, when the outer switch is in the first outer switch position, it is configured to freely rotate without mechanical interruption.

2. The ratchet drive mechanism of claim 1, wherein the outer switch is biased to the first outer switch position by a spring.

3. The ratchet drive mechanism of claim 2, wherein the spring is a helical spring surrounding the shaft.

4. The ratchet drive mechanism of claim 3, wherein the spring is confined between the inner switch and the outer switch.

5. The ratchet drive mechanism of claim 1, wherein the inner switch at least partially surrounds the ratchet drum.

6. The ratchet drive mechanism of claim 1, wherein the outer switch at least partially surrounds the inner switch.

7. The ratchet drive mechanism of claim 1, wherein the inner switch is restrained against forward movement along the shaft by a first C-clip positioned in a first groove on the shaft.

8. The ratchet drive mechanism of claim 1, wherein the outer switch is restrained against forward movement along the shaft by a second C-clip positioned in a second groove on the shaft.

9. The ratchet drive mechanism of claim 1, wherein the inner switch has a plurality of radially extending teeth for engagement with mating teeth on the outer switch.

10. The ratchet drive mechanism of claim 1, wherein the inner switch has at least one post, extending parallel with the shaft axis, for engaging with and moving the pawls.

11. The ratchet drive mechanism of claim 10, wherein each pawl has an arm extending perpendicular to a direction of movement of the pawl, the arm being configured to directly contact the post.

12. A method of selecting a drive direction in a ratchet drive mechanism, comprising:
providing a first member to rotate about an elongate drive shaft having an axis;
configuring the first member to be capable of freely rotating about the drive shaft when the first member is in an original position along the shaft;
axially retracting the first member along the shaft from the original position;
engaging a second member with the first member, the second member being configured to rotate about the drive shaft;
rotating the first member;
rotating the second member;
altering the drive direction of the drive mechanism; and
returning the first member to the original position.

13. The method of claim 12, wherein retracting the first member includes retracting the first member against a force exerted by a biasing member.

14. The method of claim 12, wherein rotating the second member includes rotating the second member by rotating the first member.

15. The method of claim 12, wherein altering the drive direction includes altering the direction by rotating the second member.

16. The method of claim 12, wherein returning the first member to the original position includes manually releasing the first member after changing the drive direction, and permitting a biasing member to return the first member to the original position.

17. The method of claim 16, wherein permitting a biasing member to return the first member includes providing no manual assistance in returning the first member to the original position.
